(19) United States
(12) Patent Application Publication
(10) Pub. No.: US 2025/0159687 A1
(43) Pub. Date: May 15, 2025

(54) INTER-DEVICE UPLINK CONTROL CHANNEL DESIGN

(71) Applicant: Dell Products, L.P., Round Rock, TX (US)

(72) Inventor: Ali Esswie, Calgary (CA)

(21) Appl. No.: 18/506,888

(22) Filed: Nov. 10, 2023

(51) Int. Cl. H04W 72/21; H04L 5/00; H04W 72/1273

(52) U.S. Cl. CPC H04W 72/21; H04L 5/0055; H04W 72/1273

(57) ABSTRACT

An extended reality processing unit may receive from a radio access network node control information reporting information in a control information reporting configuration. The processing unit may receive, via long-range radio resources, downlink payload directed to the processing unit or directed to one or more extended reality appliances communicatively coupled with the processing unit. The processing unit may attempt to decode the downlink payload and may transmit to the node status indications indicative of success or failure to decode the payload corresponding to multiple devices, including the processing unit and/or one or more appliances. The processing unit may locally store to a memory a successfully decoded packet directed to an appliance. The processing unit may transmit/retransmit the locally stored packet to the appliance via short-range resources and may retain the successfully decoded packet in the memory until receiving via short-range resources an acknowledgement that the appliance successfully received/decoded the packet.

### BACKGROUND

The ‘New Radio’ (NR) terminology that is associated with fifth generation mobile wireless communication systems (“5G”) refers to technical aspects used in wireless radio access networks (“RAN”) that comprise several quality of service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary. A RAN node may activate a network energy saving mode to reduce power consumption.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise receiving, from a radio access network node by a first user equipment comprising a processor, a control information reporting configuration, which may comprise control information reporting information. The control information reporting information may comprise at least one resource grant indication indicative of at least one uplink control channel resource usable, by the first user equipment, to transmit at least one status indication corresponding to downlink protocol data unit traffic directed to the first user equipment or directed to at least one second user equipment communicatively coupled with the first user equipment. The first user equipment may comprise an extended reality processing unit. The second user equipment may comprise an end extended reality appliance. The method may further comprise receiving, by the first user equipment, at least one downlink protocol data unit and transmitting, by the first user equipment to the radio access network node using the at least one uplink control channel resource, at least one status indication indicative of at least one decoding status corresponding to at least one decoding attempt to decode the at least one downlink protocol data unit.

The at least one downlink protocol data unit may be directed to the at least one second user equipment.

The at least one decoding status may correspond to the at least one decoding attempt, by the first user equipment, having been determined to be at least one failure to successfully decode the at least one downlink protocol data unit, and wherein the at least one status indication comprises at least one negative acknowledgement (“NACK”) indicative of the at least one failure to successfully decode the at least one downlink protocol data unit.

In an embodiment, the at least one decoding status may be a first decoding status. The at least one status indication may be a first status indication. The at least one decoding attempt may be a first decoding attempt, by the first user equipment, to decode the at least one downlink protocol data unit. The first decoding status may be an acknowledgement indication indicative of a first result of the first decoding attempt being a successfully decoded downlink protocol data unit. The method may further comprise storing, by the first user equipment to a memory, the successfully decoded downlink protocol data unit and transmitting, by the first user equipment to the at least one second user equipment, the successfully decoded downlink protocol data unit. The method may further comprise receiving, by the first user equipment from the at least one second user equipment, a second status indication indicative of a second decoding attempt, by the at least one second user equipment, to decode the successfully decoded downlink protocol data unit and, based on the second status indication, performing, by the first user equipment, a communication operation with respect to the successfully decoded downlink protocol data unit.

In an embodiment, the second status indication may be indicative of the second decoding attempt, by the at least one second user equipment, having been determined to be a failure to successfully decode the successfully decoded downlink protocol data unit. The communication operation may comprise retransmitting, by the first user equipment to the at least one second user equipment, the successfully decoded downlink protocol data unit.

In an embodiment, the receiving of the second status indication and the retransmitting of the successfully decoded downlink protocol data unit to the at least one second user equipment may facilitate avoiding, by the at least one second user equipment, transmitting, to the radio access network node, (e.g., via a long-range wireless resource) the second status indication indicative of the failure, by the at least one second user equipment, to successfully decode the successfully decoded downlink protocol data unit. The second status indication may comprise a NACK indication.

In an embodiment, the second status indication may be indicative of the second decoding attempt, by the at least one second user equipment, having been determined to be a success in decoding the successfully decoded downlink protocol data unit. The communication operation may comprise flushing, by the first user equipment from the memory, the successfully decoded downlink protocol data unit.

In an embodiment, a first downlink protocol data unit of the at least one downlink protocol data unit may be directed to the first user equipment. A second downlink protocol data unit of the at least one downlink protocol data unit may be directed to the at least one second user equipment. A first status indication of the at least one status indication may be indicative of a first decoding status of the at least one decoding status corresponding to a first decoding attempt of the at least one decoding attempt, by the first user equipment, to decode the first downlink protocol data unit. A second status indication of the at least one status indication may be indicative of a second decoding status of the at least one decoding status corresponding to a second decoding attempt of the at least one decoding attempt, by the at least one second user equipment, to decode the second downlink protocol data unit. The control information reporting configuration may comprise a transmission multiplexing format indication indicative of a transmission multiplexing format usable by the first user equipment to transmit, to the radio access network node, the at least one status indication, and wherein the first status indication and the second status indication are transmitted, using the at least one uplink control channel resource, according to a status indication multiplexing format. The status indication multiplexing format may be one of: a code multiplexing format or a sequence multiplexing format.

In another example embodiment, an extended reality processing unit may comprise a processor configured to process executable instructions that, when executed by the processor, facilitate performance of operations, comprising receiving, from a radio network node, a control information reporting configuration comprising a resource grant indication indicative of an uplink control channel resource usable to transmit at least one status indication corresponding to downlink traffic directed to an extended reality appliance that is communicatively coupled with the extended reality processing unit. The operations may further comprise receiving, from the radio network node, a downlink packet corresponding to a traffic flow directed to the extended reality appliance, attempting to decode the downlink packet to result in a decoding attempt, and transmitting, to the radio network node via the uplink control channel resource, a status indication indicative of a decoding status corresponding to the decoding attempt.

In an embodiment, the extended reality appliance may be a first extended reality appliance. The downlink packet may be a first downlink packet. The traffic flow directed to the extended reality appliance may be a first traffic flow. The decoding attempt may be a first decoding attempt. The decoding status may be a first decoding status. The status indication may be a first status indication indicative of the first decoding status. The operations may further comprise receiving a second downlink packet corresponding to a second traffic flow directed to a second extended reality appliance communicatively coupled with the extended reality processing unit, attempting to decode the second downlink packet to result in a second decoding attempt, and transmitting, to the radio network node via the uplink control channel resource, a second status indication indicative of a second decoding status corresponding to the second decoding attempt.

The first status indication and the second status indication may be transmitted in an uplink control information message. The first status indication and the second status indication may be multiplexed in the uplink control information message according to one of: a code-based multiplexing format or a sequence-based multiplexing format.

In an embodiment, the first decoding status may correspond to a first successful decoding of the first downlink packet. The first status indication may be an ACK indicative of the first successful decoding of the first downlink packet. The operations may further comprise storing the first downlink packet to a memory and transmitting the first downlink packet to the first extended reality appliance. Responsive to the transmitting of the first downlink packet to the first extended reality appliance, the operations may further comprise receiving a third status indication indicative of a second successful decoding, by the first extended reality appliance, of the first downlink packet and responsive to the receiving of the third status indication, erasing the first downlink packet from the memory.

In an embodiment, the first decoding status may correspond to a successful decoding of the first downlink packet. The first status indication may be an ACK indicative of the successful decoding of the first downlink packet. The operations may further comprise storing the first downlink packet to a memory and transmitting the first downlink packet to the first extended reality appliance. Responsive to the transmitting of the first downlink packet to the first extended reality appliance, the operations may further comprise receiving a third status indication indicative of an unsuccessful decoding, by the first extended reality appliance, of the first downlink packet. Responsive to the receiving of the third status indication, the operations may further comprise retransmitting the first downlink packet to the first extended reality appliance.

In an embodiment, the downlink packet may be a first downlink packet. The decoding attempt may correspond to a failure, by the extended reality processing unit, to decode the downlink packet. The status indication may comprise a negative acknowledgement (“NACK”). Responsive to the transmitting of the NACK, the operations may further comprise receiving, from the radio network node, a second downlink packet that is a retransmitted version of the first downlink packet. The operations may further comprise successfully decoding the second downlink packet to result in a successfully decoded second downlink packet, storing the successfully decoded second downlink packet to a memory, and transmitting the successfully decoded second downlink packet to the extended reality appliance.

In yet another example embodiment, a non-transitory machine-readable medium may comprise executable instructions that, when executed by a processor of an extended reality processing unit, facilitate performance of operations, comprising receiving, from a radio network node, a control information reporting configuration comprising at least one resource grant indication indicative of at least one control channel resource usable to transmit at least one status indication corresponding to extended reality traffic directed to at least one extended reality appliance that is communicatively coupled with the extended reality processing unit. The operations may comprise receiving, from the radio network node, a first downlink packet corresponding to a first extended reality traffic flow directed to a first extended reality appliance of the at least one extended reality appliance. The operations may further comprise attempting to decode the first downlink packet to result in a first decoding attempt. The operations may comprise receiving, from the radio network node, a second downlink packet corresponding to a second extended reality traffic flow directed to a second extended reality appliance of the at least one extended reality appliance. The operations ma further comprise attempting to decode the second downlink packet to result in a second decoding attempt and transmitting, to the radio network node employing the at least one control channel resource, a first status indication indicative of a first decoding status corresponding to the first decoding attempt and a second status indication indicative of a second decoding status corresponding to the second decoding attempt.

In an embodiment, the first status indication may be a negative acknowledgement (“NACK”). The second status indication may be an acknowledgement (“ACK”). The operations may further comprise storing the second downlink packet to a memory of the extended reality processing unit and transmitting, to the second extended reality appliance the second downlink packet. Responsive to the transmitting of the NACK, the operations may further comprise receiving from the radio network node, a retransmitted version of the first downlink packet, storing the retransmitted version of the first downlink packet to the memory, and transmitting to the first extended reality appliance the retransmitted version of the first downlink packet.

### BRIEF DESCRIPTION OF THE DRAWINGS

FIG. 1 illustrates wireless communication system environment.

FIG. 2 illustrates an example virtual reality appliance.

FIG. 3 illustrates an example environment with an anything reality appliance tethered to a user equipment managing related traffic flows with the appliance.

FIG. 4 illustrates example control information reporting information in a control information reporting configuration.

FIG. 5 illustrates an example uplink control information multiplexing message.

FIG. 6 illustrates timing diagram of an example embodiment of uplink traffic being transmitted to a radio access network node according to autonomously granted uplink resources.

FIG. 7 illustrates a flow diagram of an example embodiment method of facilitating applying a relative quality of service to determine transmission of a related traffic flow.

FIG. 8 illustrates a block diagram of an example method embodiment.

FIG. 9 illustrates a block diagram of an example extended reality processing unit.

FIG. 10 illustrates a block diagram of an example non-transitory machine-readable medium embodiment.

FIG. 11 illustrates an example computer environment.

FIG. 12 illustrates a block diagram of an example wireless user equipment.

### DETAILED DESCRIPTION

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

As an example use case that illustrates example embodiments disclosed herein, Virtual Reality (“VR”) applications and VR variants, (e.g., mixed and augmented reality) may at some time perform best when using NR radio resources associated with URLLC while at other times lower performance levels may suffice. A virtual reality smart glass device may consume NR radio resources at a given broadband data rate having more stringent radio latency and reliability criteria to provide a satisfactory end-user experience.

5G systems should support ‘extended reality’ (“XR”) services. XR services may refer to, or may be referred to as, anything reality services. XR services may comprise VR applications, which are widely adopted XR applications that provide an immersive environment that can stimulate the senses of an end user such that he, or she, may be ‘tricked’ into the feeling of being within a different environment than he, or she, is actually in. XR services may comprise Augmented Reality (‘AR’) applications that may enhance a real-world environment by providing additional virtual world elements via a user's senses that focus on real-world elements in the user's actual surrounding environment. XR services may comprise Mixed Reality cases (“MR”) applications that help merge, or bring together, virtual and real worlds such that an end-user of XR services interacts with elements of his, or her, real environment and virtual environment simultaneously.

Different XR use cases may be associated with certain radio performance targets. Common to XR cases, and unlike URLLC or eMBB, high-capacity links with stringent radio and reliability levels are typically needed for a satisfactory end user experience. For instance, compared to a 5 Mbps URLLC link with a 1 ms radio budget, some XR applications need 100 Mbps links with a couple of milliseconds of allowed radio latency. Thus, 5G radio design and associated procedures may be adapted to the new XR QoS class and associated performance targets.

An XR service may be facilitated by traffic having certain characteristics associated with the XR service. For example, XR traffic may typically be periodic with time-varying packet size and packet arrival rate. In addition, different packet traffic flows of a single XR communication session may affect an end user's experience differently. For instance, a smart glass that is streaming 180-degree high-resolution frames may use a large percentage of a broadband service's capacity for fulfilling a user experience. However, frames that are to be presented to a user's pose direction (e.g., front direction) are the most vital for an end user's satisfactory user experience while frames to be presented to a user's periphery vision have less of an impact on a user's experience and thus may be associated with a lower QoS requirement for transport of traffic packets as compared to a QoS requirement for transporting the pose-direction traffic flow. Therefore, flow differentiation that prioritizes some flows, or some packets, of a XR session over other flows or packets may facilitate efficient use of a communication system's capacity to deliver the traffic. Furthermore, XR capable devices (e.g., smart glasses, projection wearables, etc.) may be more power-limited than conventional mobile handsets due to the limited form factor of the devices. Thus, techniques to maximize power saving operation at a XR capable device is desirable. Accordingly, a user equipment device accessing XR services, or traffic flows of an XR session, may be associated with certain QoS parameter criterion/criteria to satisfy performance targets of the XR service. Measured traffic values, or metrics, may correspond to a QoS, or analyzed with respect to, parameter criterion/criteria, such as, for example, a data rate, an end-to-end latency, or a reliability.

High-capacity-demanding services, such as virtual reality applications, may present performance challenges to even 5G NR capabilities. Thus, even though 5G NR systems may facilitate and support higher performance capabilities, the radio interface should nevertheless be optimized to support extreme high capacity and low latency requirements of XR applications and XR data traffic.

Multi-modal XR applications may integrate different technologies to offer a versatile and comprehensive user experience. For example, a multi-modal XR application might use VR to immerse users in a virtual training environment and then seamlessly switch to AR or MR to provide real-time feedback or overlay instructional information corresponding to physical objects that may appear in an environment viewed by an XR user. Such feedback or instructional information may relate to stationary objects or may be information that does not change frequently and may be referred to as stable information.

An advantage of multi-modal XR applications is the adaptability to facilitate different contexts and different user preferences. An XR application can provide varying levels of immersion and interaction, allowing users to choose the most suitable mode of engagement based on the user's needs or the specific task at hand. Additionally, multi-modal XR can enable collaborative experiences, allowing users in different physical locations to interact within the same virtual space.

Uses of multi-modal XR applications extend beyond entertainment and gaming, with widespread adoption in fields such as healthcare, education, engineering, and marketing. Medical practitioners can use multi-modal XR applications to simulate complex surgeries, educators can create interactive and immersive learning experiences, and architects can visualize and modify building designs in real-time.

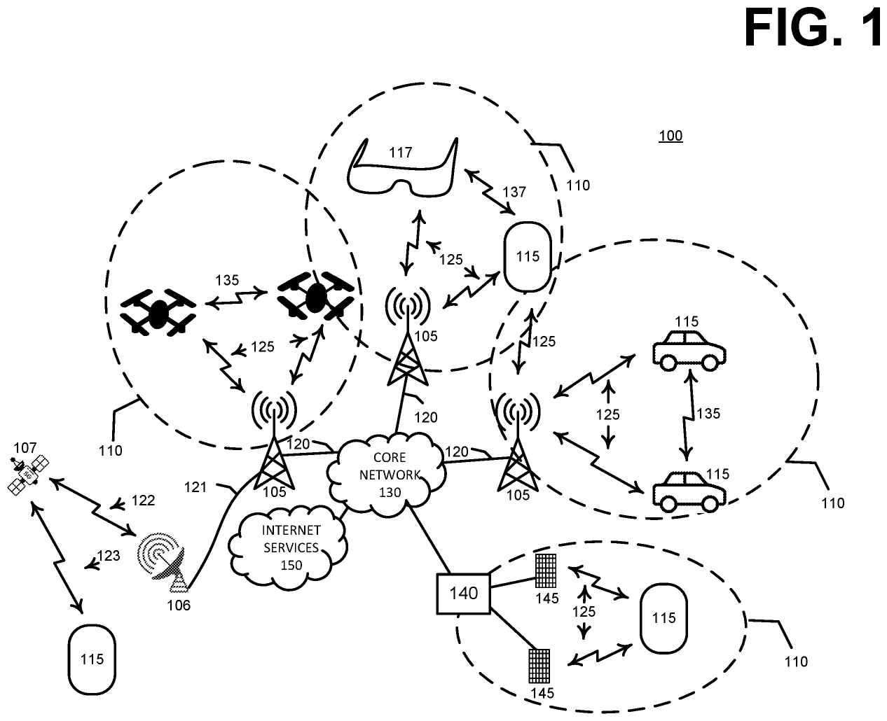

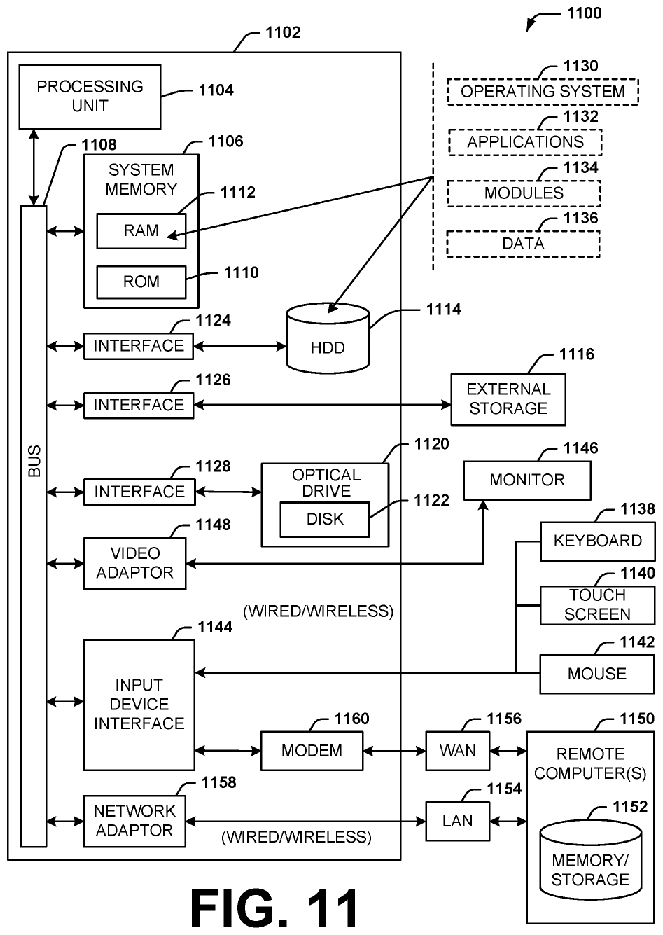

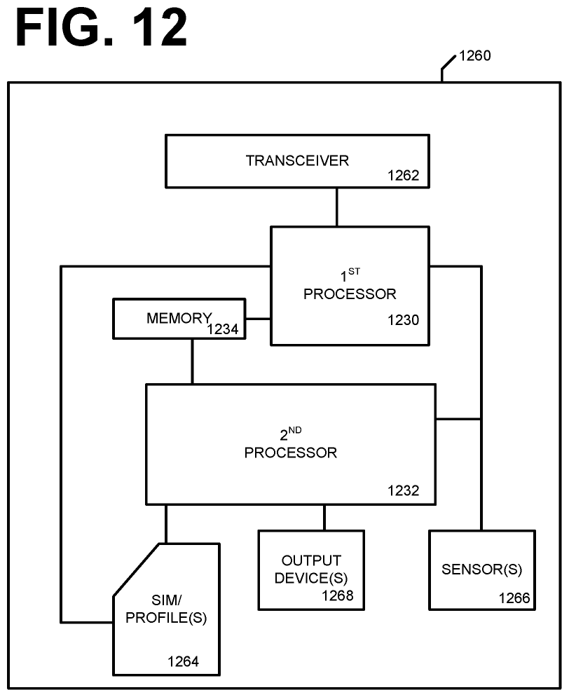

Turning now to the figures, FIG. 1 illustrates an example of a wireless communication system 100 that supports blind decoding of PDCCH candidates or search spaces in accordance with one or more example embodiments of the present disclosure. The wireless communication system 100 may include one or more base stations 105, one or more user equipment (“UE”) devices 115, and core network 130. In some examples, the wireless communication system 100 may comprise a long-range wireless communication network, that comprises, for example, a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, laptop computers, tablet computers, automobiles or other vehicles, or drones or other aircraft. Another example of a UE may be a virtual reality/extended reality appliance 117, such as smart glasses, a virtual reality headset, an augmented reality headset, and other similar devices that may provide images, video, audio, touch sensation, taste, or smell sensation to a wearer. A UE, such as XR appliance 117, may transmit or receive wireless signals with a RAN base station 105 via a long-range wireless link 125, or the UE/XR appliance may receive or transmit wireless signals via a short-range wireless link 137, which may comprise a wireless link with a UE device 115, such as a Bluetooth link, a Wi-Fi link, and the like. A UE, such as appliance 117, may simultaneously communicate via multiple wireless links, such as over a link 125 with a base station 105 and over a short-range wireless link. XR appliance 117 may also communicate with a wireless UE via a cable, or other wired connection. An XR appliance 117 may offload processing functionality or functionality related to communicating with a RAN, to a user equipment 115, which may be referred to as an intermediate user equipment or an XR processing unit. An XR processing unit or a RAN, or a component thereof, may be implemented by one or more computer components that may be described in reference to FIG. 11. An XR processing unit may also comprise components described in reference to FIG. 12

Continuing with discussion of FIG. 1, base stations 105, which may be referred to as radio access network nodes or cells, may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one component carrier, or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications, such as sidelink communication, may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both. In FIG. 1, vehicle UE 116 is shown inside a RAN coverage area and vehicle UE 118 is shown outside the coverage area of the same RAN. Vehicle UE 115 wirelessly connected to the RAN may be a sidelink relay to in-RAN-coverage-range vehicle UE 116 or to out-of-RAN-coverage-range vehicle UE 118.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

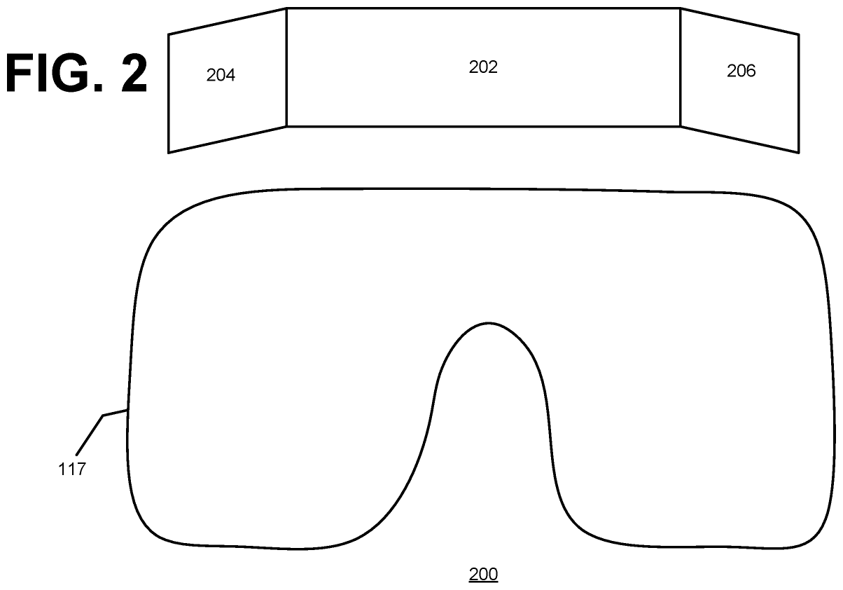

Turning now to FIG. 2, the figure illustrates a virtual reality (“VR”) application system 200. In system 200, wearable VR appliance 117 is shown from a wearer's, or viewer's, perspective. VR appliance 117 may comprise a center, or pose, visual display portion 202, a left visual display portion 204 and a right visual display portion 206, that may be used to display main visual information, left peripheral visual information, and right peripheral visual information, respectively. As shown in the figure, the portions 202, 204, and 206 are delineated by distinct lines, but it will be appreciated that hardware or software may facilitate gradual transition from main and peripheral information display.

As discussed above, different XR use cases may require different corresponding radio performance. Typically, for XR use cases but unlike for URLLC or eMBB use cases, high-capacity radio links that carry XR data traffic (e.g., data flows that comprise visual information) with stringent radio levels (e.g., latency) and reliability levels are required for a reasonable end user experience. For example, compared to a 5 Mbps URLLC link with a 1 ms radio latency budget, some XR applications require 100 Mbps links with about 2 mS allowed radio latency.

From research, several characteristics have been determined that for XR data traffic: (1) XR traffic characteristics are typically periodic with time-varying packet size and packet arrival rate; (2) XR capable devices may be more power-limited than conventional mobile handsets, (e.g., smart glasses, projection wearables, etc.) due to the limited form factor of the devices; (3) multiple data packet flows corresponding to different visual information of a given XR session are not perceived by a user as having the same impact on the end user experience.

Thus, in addition to needing XR-specific power use efficiency, smart glasses, such as wearable appliance 117, streaming 180-degree high-resolution frames requires broadband capacity for providing an optimum user experience. However, it has been determined that data corresponding to the frames that carry main, or center visual information (i.e., the pose or front direction) are the most vital for end user satisfaction, while the frames corresponding to peripheral visual information have a lesser impact on a user's experience. Therefore, accepting higher latency for less important traffic flows so that resources that would otherwise be allocated to the less important traffic flows can be used for traffic flows corresponding to more important traffic, or to devices that carry the more important traffic, may be used to optimize overall capacity and performance of a wireless communication system, such as a 5G communication system using NR techniques, method, systems, or devices. For example, a wireless data traffic flow carrying visual information for display on center, or pose, visual display portion 202 may be prioritized higher than a wireless data traffic flow carrying visual information for left visual display portion 204 or for right visual display portion 206.

The performance of a communication network in providing an XR service may be at least partially determined according to satisfaction of a user of the XR services. Each XR-service-using user equipment device may be associated with certain QoS parameter criterion/criteria with respect to which measured values, or metrics, corresponding to traffic flows that facilitate XR service may be analyzed. Adjusting scheduling of traffic such that a measured traffic flow metric satisfies a QoS parameter, such as, for example, a data rate, an end-to-end latency, or a reliability may be beneficial to a user's XR experience.

A 5G NR radio system typically comprises a physical downlink control channel (“PDCCH”), which may be used to deliver downlink and uplink control information to cellular devices. The 5G control channel may facilitate operation according to requirements of URLLC and eMBB use cases and may facilitate an efficient coexistence between such different QoS classes.

In an embodiment, a user equipment may be deployed as an extended reality processing unit and may facilitate communication with a RAN node on behalf of a less capable end XR appliance (e.g., less capable in terms of processing power, battery capacity, transmitter power, or the like). An extended reality processing unit may comprise an ‘in-box’ processing unit/device that facilitates signaling, traffic handling, and overall radio assistance to an end XR appliance (e.g., helmets, or glasses), which may be capable of communicating directly with a RAN node but with reduced capability. Accordingly, an intermediate XR processing unit (e.g., a laptop or smartphone that is intermediate with respect to communication links between a RAN node and an end XR appliance) may facilitate relaxing a large subset of radio function and operations, traffic processing, and battery consumption load with respect to an end XR appliance thus leading to a more efficient end XR device design (e.g., requiring less battery size, dissipating less heat, etc.).

However, existing performance reporting procedures do not support such novel extended reality processing unit deployment. For example, despite performance merits related to using an intermediate XR processing unit to assist an end XR appliance, an end XR appliance must independently report back a decoding state, or status, corresponding to each received payload protocol data unit (e.g., packet). For example, according to conventional techniques, an end XR appliance that receives a packet transmitted by a RAN node must generate and transmit to the RAN node acknowledgement (“ACK”) or negative acknowledgement (“NACK”) status indications corresponding to received traffic, via uplink control channels and resources corresponding thereto, established by the RAN node for use by the end XR device. Such an exclusive control channel resources grant may result in degradation of uplink capacity traffic capacity with respect to the RAN node. Accordingly, embodiments disclosed herein may facilitate aggregated and prospective performance feedback reporting corresponding to XR traffic received at an XR processing unit.

According to embodiments disclosed herein, an intermediate XR processing unit may determine, compile, and report back to a serving RAN node performance feedback metrics/status indications (e.g., ACKs, NACKs) corresponding to traffic received by the XR processing unit that is directed to one or more of end XR appliances, communicatively coupled to the XR processing unit, based on a decoding status corresponding to attempts by the XR processing unit to decode the traffic. For example, when an intermediate XR processing unit successfully decodes traffic received from a RAN node that is directed towards two end XR appliances, the XR processing unit may compile an uplink feedback report, which may aggregate feedback metrics/status indication corresponding to the two different XR appliances and report the status indications to the RAN node, even before the actual end XR devices receive and decode the respective traffic. Thus, only a single uplink control channel between the RAN node and the intermediate processing unit may be used to carry performance feedback metric(s)/status indication(s) corresponding to the intermediate XR processing unit itself as well as feedback metric(s)/status indication(s) corresponding to the end XR appliances. The feedback metric(s)/status indication(s) may be transmitted by the XR processing unit according to a status indication multiplexing format.

To facilitate embodiments disclosed herein, novel user equipment decoding and traffic buffering behavior embodiments may be used. For example, an intermediate XR processing unit may buffer received traffic packets for which an aggregated performance reporting or status indications was triggered, until one or more end XR device(s) to which the received traffic is directed has/have successfully decoded the traffic. For traffic directed to one or more end XR appliances that the intermediate XR processing unit may have reported to a serving RAN node as having been successfully received and decoded (e.g., the XR processing unit sent to the RAN node one or more ACK status indications corresponding to the received traffic) the intermediate XR processing unit may facilitate re-transmission(s) of the received traffic that has been successfully decoded and stored in a memory, or buffer, locally without using radio resources corresponding to the RAN node. If an end XR device to which traffic successfully received and decoded by the intermediate XR processing unit fails to decode the traffic, payload re-transmission may occur only locally from the intermediate XR processing unit to the end XR that failed to decode the traffic. Thus, the serving RAN node, as well as scarce radio interface resources corresponding to the RAN node, may be unused for the local re-transmission(s). Accordingly, embodiments disclosed herein facilitate handling of uplink performance feedback reporting corresponding to a group of end XR appliances, which may be implementing or executing similar XR applications, leading to a more energy-efficient and processing-efficient operation at the end XR appliances that facilitates avoiding overwhelming the radio interface corresponding to the serving RAN node with uplink control channel signaling overhead.

Using current techniques, a user equipment only compiles and transmits status indications (e.g., ACK or NACK indications) regarding the user equipment's own traffic reception and decoding attempts. With conventional techniques, a decoding status report transmitted to a RAN node is typically based on actual decoding status generated by a user equipment to which traffic is directed. According to embodiments disclosed herein, a user equipment may compile and transmit to a serving RAN node status indications regarding the processing unit's own traffic as well as status indications corresponding to traffic directed to other user equipment devices. For example, a device, to which traffic is directed, that has successfully decoded a packet transmits a positive (ACK) reporting metric according to conventional techniques. However, embodiments disclosed herein facilitate the capability of a master device (e.g., an XR processing unit) sending a performance feedback report regarding traffic that is actually not yet decoded at an intended slave device (e.g., an end XR appliance) but for which decoding has been attempted at the master device. According to embodiments disclosed herein, the master device may locally buffer traffic received that is directed to a slave device, forward the buffered traffic to the slave device, and if not successfully decoded at the slave devices, may locally re-transmit the buffered traffic to the slave device without involvement of a cellular radio interface with respect to the serving RAN node. According to conventional techniques, a master device that relays traffic towards an end slave device only forwards downlink traffic without local buffering.

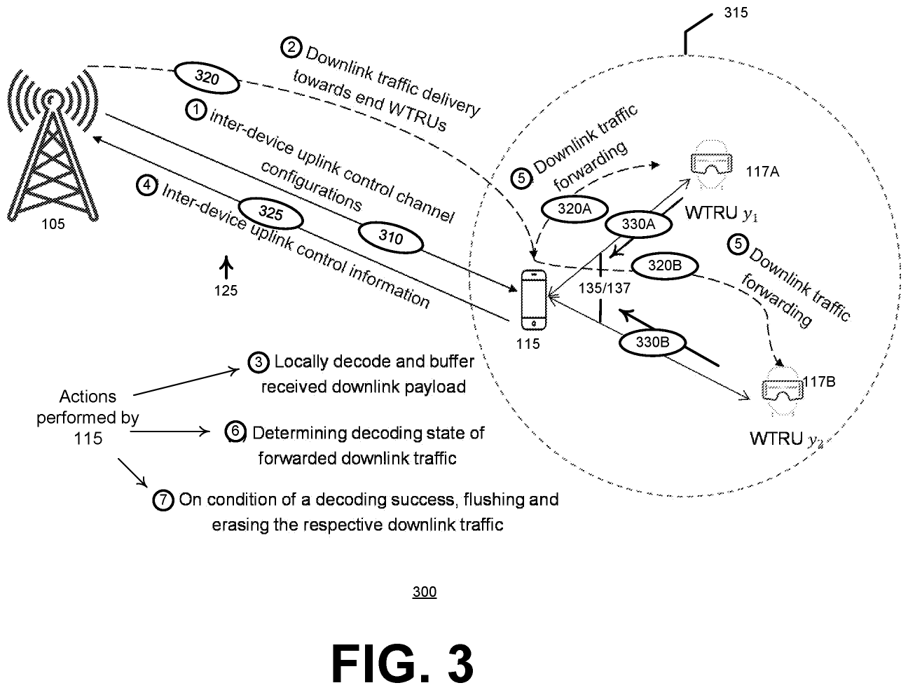

Turning now to FIG. 3, the figure illustrates an example environment 300 with an extended reality appliance 117 tethered to an extended reality processing unit user equipment 115. Appliance 117 may be referred to as an end XR appliance in reference to the relationship of being at an end of a communication session, with respect to RAN node 105, with extended reality processing unit 115 being located intermediate to the RAN node and the appliance. XR processing unit 115 may be more capable with respect to battery capacity (or may be supplied power via a wired power supply receiving power from an electrical wall outlet), or with respect to processing capability, than XR appliance 117. In an embodiment, a downlink traffic flow providing traffic to a peripheral portion 204/206 (shown in FIG. 2) of VR/XR appliance 117 may be related to a downlink traffic flow carrying traffic to be displayed by a pose portion 202 of the appliance. In another example, two different traffic flows may respectively carry traffic directed to right side 202R and left side 202L of pose portion 202 and thus may be related. In another example, an uplink traffic flow may carry traffic related to a downlink traffic flow.

Inter-device uplink control channel design.

As shown in FIG. 3, at act 1 centralized XR processing unit 115 may receive from serving RAN node 105 an inter-device uplink control channel configuration 310, which may be referred to as a control information reporting configuration. Configuration 310 may comprise at least one resource grant indication indicative of at least one uplink control channel resource usable, by XR processing unit 115, to transmit at least one status indication corresponding to downlink protocol data unit traffic directed to the XR processing unit or directed to at least one end XR appliance 117A or 117B, which may be communicatively coupled with the XR processing unit. Configuration 310 may comprise granted resource information corresponding to uplink control channel resources, an activation indication indicative of the indicated granted uplink control channel resources being usable to facilitate uplink transmission, to RAN node 105, of inter-device feedback reporting (e.g., reporting by the XR processing unit of ACK or NACK status indications corresponding to packet decoding attempts by the XR processing unit). If inter-device feedback is indicated in configuration 310 as being enabled, configuration 310 may comprise an indication of an inter-device feedback transmission mode, which may be referred to as a status indication multiplexing format, and which may be indicated as being code-based or sequence-based multiplexing. With a sequence-based feedback transmission format, processing unit 115 may sequentially transmit feedback metrics (e.g., ACKs or NACKs) via a status indication reporting message 325, corresponding to traffic 320 received at act 2 and directed to end XR devices 117A or 117B, via a set of the uplink control channel resources indicated in configuration 310 as being granted. Message 325 may comprise one or more end XR device identifier(s) respectively corresponding to one or more feedback metric/status indication(s) being transmitted via the sequence-based status indication multiplexing format. If a code-based feedback transmission status indication multiplexing format is indicated in configuration 310, central XR processing unit 115 may transmit feedback metrics corresponding to, for example, end XR appliance 117A or 117B, via an entire granted uplink control channel resource set indicated in configuration 310, wherein each status indication (e.g., ACK or NACK) reported in message 325 is encoded using a scrambling code associated with the end XR appliance 117A or 117B corresponding to a given status indication.

Accordingly, at act 3, on condition of XR processing unit 115 receiving at act 2 downlink traffic 320 directed to one or more end XR appliance 117A or 117B, XR processing unit 115 may attempt decoding one or packets corresponding to traffic 320 using decoding information corresponding to end XR appliance(s), which decoding information may have been previously configured to the XR processing unit. At act 4, depending on a decoding status (e.g., successful decoding or failure to decode) corresponding to traffic 320 determined by XR processing unit 115, the processing unit may trigger transmission of an inter-device feedback reporting of a status indication report message 325 comprising status indications, corresponding to decoding attempt(s) of traffic packets corresponding to traffic 320, according to a configured status indication multiplexing format (e.g., sequence-based multiplexing or code-based multiplexing), indicative of the determined decoding state, or status, and comprising end XR device identifiers corresponding to one or more end XR appliances 117A or 117B to which traffic 320 is directed.

As described in reference to act 3, XR processing unit 115 may locally store received and successfully decoded traffic packets corresponding to traffic 320, which may comprise traffic packets directed to one or more end XR appliances 117A or 117B, and for which traffic packets a positive (e.g., an ACK) status indication has been transmitted towards RAN node 105. At act 5, XR processing unit 115 may forward the buffered traffic that was successfully decoded towards one or more end XR appliances 117A or 117B to which the successfully decoded and buffered packets are directed, via inter-device link, for example 5G sidelink links 135 or device proprietary links 137 (which may be Wi-Fi links), and accordingly may determine at act 6 a final decoding state/status indication corresponding to the forwarded traffic packet with respect to one or more end XR appliances 117A or 117B to which the buffered traffic was transmitted by the XR processing unit (e.g., an end XR appliance may transmit to XR processing unit an ACK or NACK via the inter-device links).

At act 7, on condition of receiving a positive decoding feedback (e.g., ACK) from an end XR appliance 117A or 117B, indicative of a successful decoding of a traffic packet forwarded to one or more of the appliances, XR processing unit/115 may flush, or erase, one or more buffered traffic packets, buffered at act 3 after successful decoding by the XR processing unit, for which a positive decoding feedback indication has been received by the XR processing unit from one or more of the end XR appliances to which the ACK corresponds. However, on condition of receiving a negative decoding feedback status indication (e.g., a NACK) from one or more end XR appliances 117A or 117B, XR processing unit 115 may retain the traffic corresponding to the NACK in the local storage buffer and may retransmit the packet corresponding to the NACK via local inter-device payload re-transmission using links 137/137. Thus, RAN node 105 may avoid the burden of retransmitting, via resources corresponding to a long-range link 125 between the RAN node and an XR appliance, multiple XR traffic packets, unsuccessfully decoded by an end XR appliances, by offloading retransmission to XR processing unit 115 such that the XR processing unit facilitates retransmission via local, non-cellular links 135 or 137. Furthermore, a single uplink control channel may be used to deliver, via a single message 325, performance feedback metrics/status indications corresponding to attempts by XR processing unit to decode traffic packets directed to the XR processing unit itself and/or directed to one or more of end XR appliances 117A or 117B, thus minimizing use of long-range radio link resources to carry uplink control information.

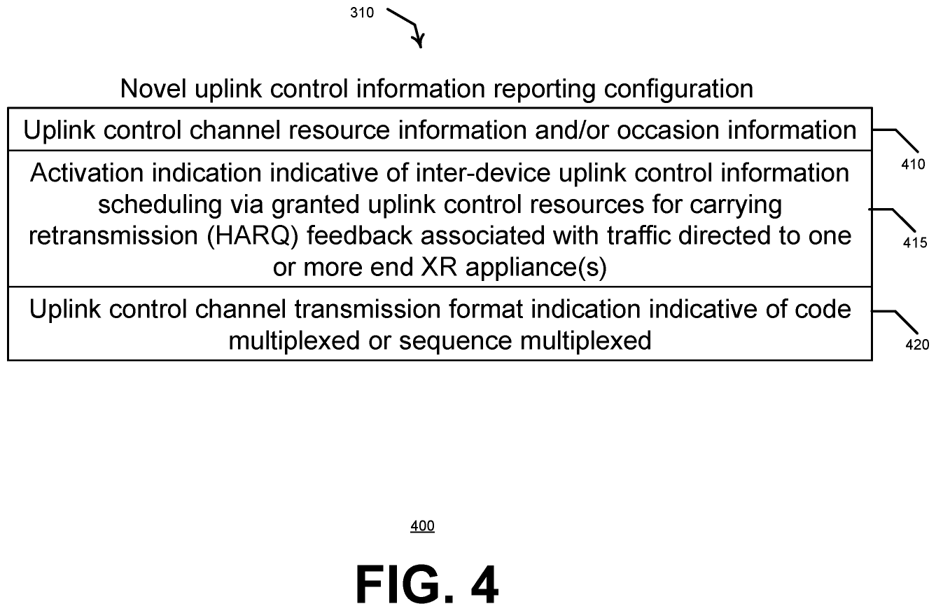

Turning now to FIG. 4, the figure illustrates an example control information reporting configuration 310. An extended reality processing unit may receive configuration information 310 comprising granted resource information 410 indicative of resources (e.g., time or frequency resources) corresponding to an uplink control channel usable to transmit status indications in a report, such as report 325 described in reference to FIG. 3. Configuration information in configuration 310 may comprise an activation indication 415 indicative of whether inter-device feedback reporting via a message 325 is supported via granted uplink control channel resources indicated in resource information 410. Configuration information 310 may comprise an inter-device feedback transmission mode indication 420, indicative of a status indication multiplexing format.

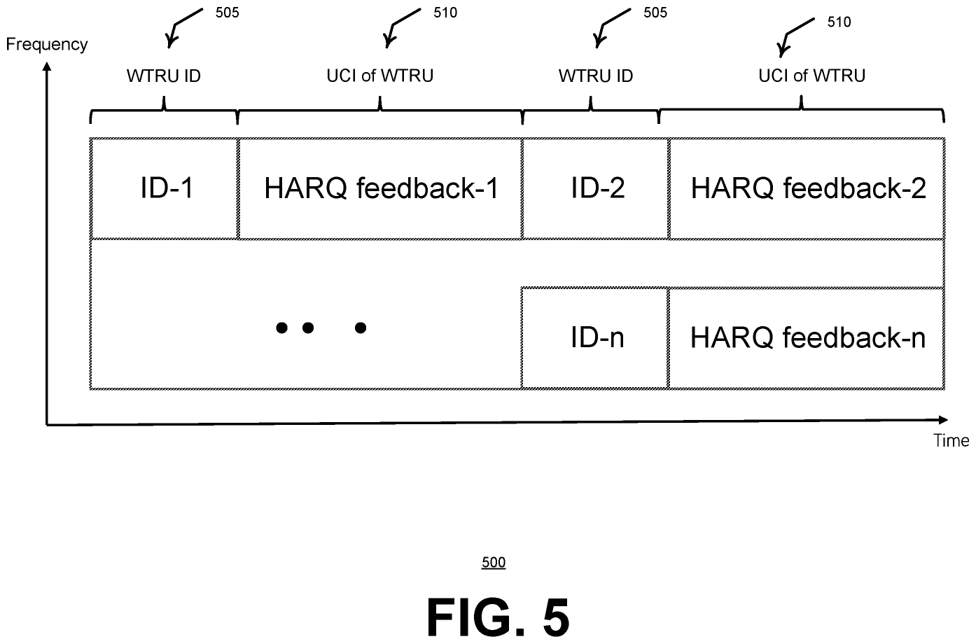

Turning now to FIG. 5, the figure illustrates an example transmission multiplexing format 500 that may be used in an uplink control information message, such as message 325 described in reference to FIG. 3, to transmit status indications corresponding to success or failure by an XR processing unit to decode packets directed to the XR processing unit and/or end XR appliances. In the embodiment exemplified in format 500, a sequence-based feedback transmission format is shown, according to which an XR processing unit may transmit feedback metrics (e.g., status indications such as ACK or NACK indications) corresponding to the XR processing unit or end XR devices sequentially or in parallel with respect to time, via a subset, or subsets, of granted uplink control resources granted in configuration 310. Information transmitted according to format 500 may comprise one or more device indications 505 indicative of one or more end XR appliance(s) corresponding to feedback metric(s)/status indication(s) 510. In an embodiment not shown in FIG. 5, with a code-based feedback transmission format, an XR processing unit may transmits, in parallel with respect to time, status indications of multiple user equipment via an entire granted resource set of an uplink control channel as granted in configuration 310. With code-based multiplexing, the XR processing unit may encode each status indication contained in an uplink message 325 using a scrambling code associated with the user equipment to which a status indication corresponds. Instead of an identifier preceding a status indication (e.g., an identifier 505 receiving an ACK/NACK indication 510) as shown in FIG. 5, which depicts sequence-based multiplexing, multiple status indications may be transmitted in an uplink control channel message and may be separately encoded with a scrambling code corresponding, respectively, to WTRUs (e.g., an XR processing unit or one or more end XR appliances) that generated the status indications in a message 325 in a code-based multiplexing embodiment.

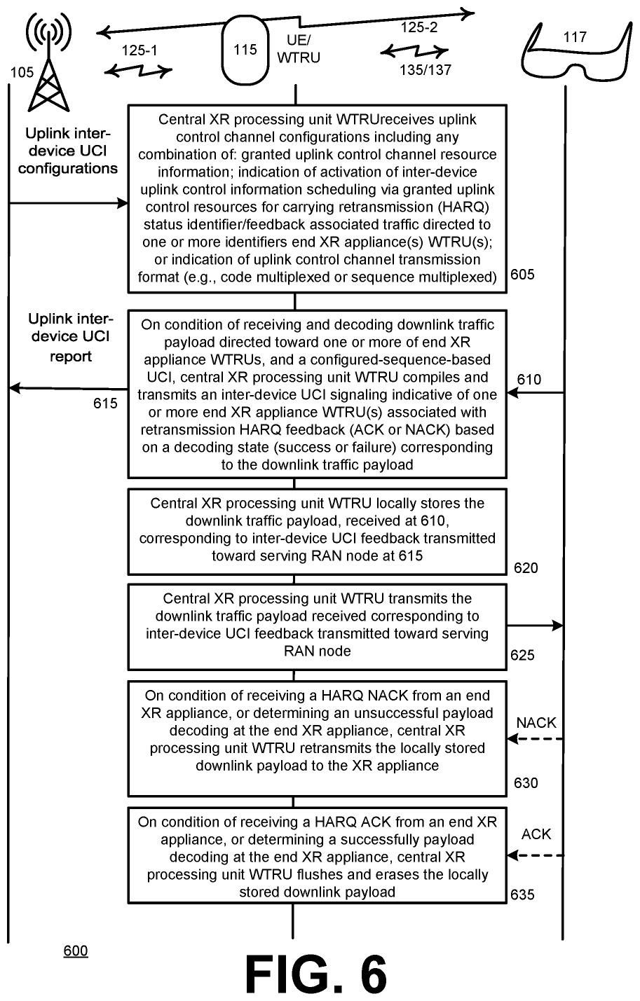

Turning now to FIG. 6, the figure illustrates a timing diagram of an example embodiment method 600 to facilitate indicating status of downlink traffic packets corresponding to XR processing unit 115 or end XR appliance 117. At act 605, central XR processing unit/WTRU 115, which may be configured to handle, manage, or otherwise facilitation, various radio functions, typically corresponding to a serving RAN node, with respect to one or more in-proximity end XR appliances/WTRUs 117, may receive from RAN node 105 an uplink control channel configuration, which may be referred to as control information reporting configuration, which may contain information described shown in, and described in reference to, FIG. 4. The control information reporting configuration may comprise granted uplink control channel resource information (e.g., time and frequency resources). The control information reporting configuration may comprise an activation indication indicative of inter-device uplink control information (“UCI”) scheduling via the granted uplink control resources for carrying retransmission status indications (e.g., HARQ feedback) via a message 325 described in reference to FIG. 3, associated with traffic directed to one or more end XR appliances 117 or directed to XR processing unit 115. The control information reporting configuration may comprise uplink control channel transmission format information, which may be referred to as a transmission multiplexing format indication, indicative of a transmission multiplexing format, for example code-multiplexing or sequence-multiplexing, applicable to transmission of status indications corresponding to XR processing unit 115 or one or more XR appliances 117. (Status indications corresponding to more than one XR appliance 117 and/or XR processing unit 115 may be transmitted in a single uplink control information message 325 according to a multiplexing format indicated in the control information reporting configuration.)

At act 610, central XR processing unit 115 may receive downlink payload directed to the XR processing unit WTRU or directed toward one or more end XR appliance(s) 117. At act 615, XR processing unit 115 may transmit to radio access network node 105, in a UCI message, one or more status indications indicative of success or failure, by XR processing unit, to decode traffic directed to one or more end XR appliances 117 or directed to the XR processing unit itself. XR processing unit 115 may transmit the one or more status indications in the UCI message to radio access network node 105 according to a transmission multiplexing format indicated in the uplink control channel configuration received at act 605. XR processing unit 115 may compile, or generate, the UCI message according to a transmission multiplexing format, for example a sequence-based transmission multiplexing format or a code-based transmission multiplexing format and may transmit at act 615 the UCI message according to one or more uplink control channel resources indicated in the configuration received at act 605.

At act 620, XR processing unit 115 may locally store the downlink traffic received at act 610 that the XR processing unit successfully decoded. At act 625, XR processing unit 115 may forward traffic received at act 610 to an end XR appliance 117 to which the traffic received at act 610 is directed. If XR processing unit 115 receives at act 630 a HARQ NACK status indication from one or more end XR appliance(s) 117 to which traffic was forwarded at act 625, the XR processing unit may retransmit the traffic to the one or more end XR appliance(s). If XR processing unit 115 receives at act 635 a HARQ ACK status indication from one or more end XR appliance(s) 117 to which traffic was forwarded at act 625, the XR processing unit may flush, or erase, the downlink payload locally stored at act 620.

Thus, after XR processing unit 115 receiving, via links 125-1, from RAN 105 a payload packet, directed towards one or more end XR appliance 117, and successfully decoding the payload packet, the XR processing unit can issue a feedback (ACK/NACK) transmission (e.g., the XR processing unit can transmit a status indication) towards RAN 105 indicative of a decoding status (e.g., successful decoding or failure to decode) corresponding to an attempt, by the XR processing unit, to decode the payload packet. By locally storing, by XR processing unit 115, payload directed to an end XR processing appliance 117, the XR processing unit can transmit to RAN 105 an ACK or NACK corresponding to the received payload before an end XR appliance to which the payload is directed actually receives and decodes the payload. After receiving from an end XR appliance 117 an ACK corresponding to the payload packet, XR processing unit 115 may flush, or erase, the stored payload. If XR processing unit 115 receives a NACK from end XR appliance 117 to which locally stored payload is directed, the XR processing unit may retransmit the stored payload to the end XR appliance thus facilitating avoidance, by the end XR appliance, of using long-range radio resources corresponding to a link 125-2 to transmit the NACK to the radio access network node 105 and facilitating avoidance by the radio access network node of retransmitting the payload packet to the end XR appliance via resources corresponding to link 125-2. XR processing unit 115 can send ACK/NACK feedback corresponding to one or more packet(s) directed to another device that has not yet received or attempted to decode the packet(s). Accordingly, as long as XR processing unit can receive and decode packets from RAN 105, the XR processing unit may send to RAN 105 an ACK or NACK, thus reducing delay and stall related to HARQ reporting, regardless of reception quality at an end XR devices to which payload is directed, and the XR processing unit may facilitate delivery of payload directed to an end XR appliance even if multiple retransmissions via inter-device links occur (e.g., retransmission by XR processing unit 115 to an end XR appliance 117 via links 135/137 between the XR processing unit 115 and end XR appliance 117), thus reducing use of radio resources, corresponding to long range link(s) 125-2 between RAN 105 and an end XR appliance 117, to retransmit payload.

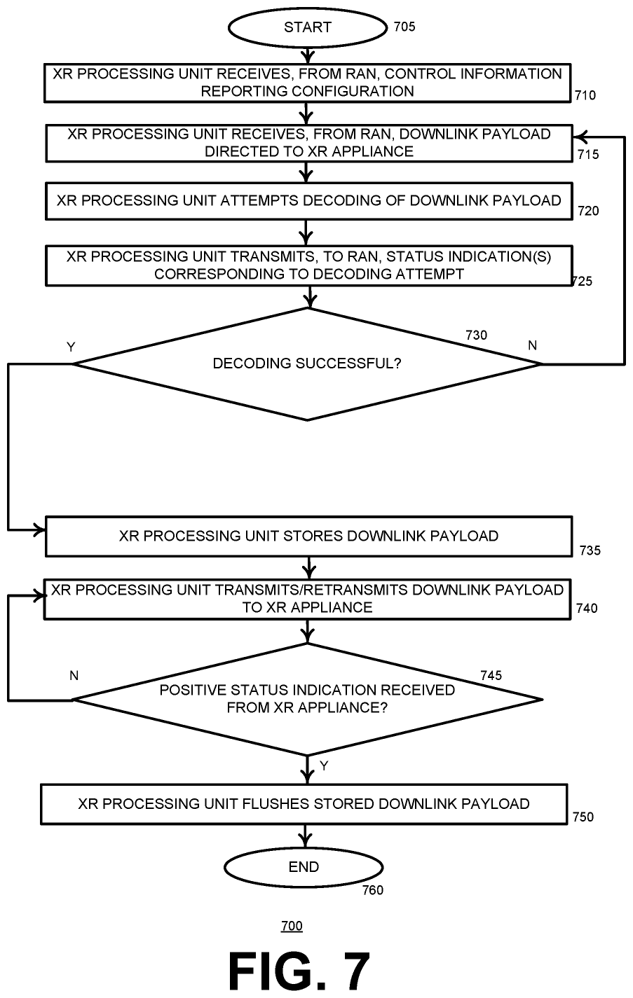

Turning now to FIG. 7, the figure illustrates a flow diagram of an example embodiment 700. Method 700 begins at act 705. At act 710, a user equipment, which may be an extended reality processing unit, or which may comprise an extended reality processing unit, may receive from a serving RAN node a control information reporting configuration. The control information reporting configuration may comprise information described in reference to configuration information 310 shown in FIG. 4. At act 715, the XR processing unit may receive from the serving RAN node downlink traffic payload, for example a packet, or packets, that is/are directed to one or more end XR appliances or that is/are directed to the XR processing unit itself. At act 720, the XR processing unit may attempt to decode one or more of the packet/packets received at act 715. At act 725, the XR processing unit may transmit to the serving a control channel information message comprising one or more status indications indicative of the one or more attempts to decode the one or more packets at act 720. The control channel information message may be an uplink control channel information message and may comprise one or more ACK status indication(s) or NACK status indication(s) corresponding to attempts to decode the traffic payload received at act 715.

At act 730, the extended reality processing unit may determine whether attempts to decode traffic received at 715 was/were successful. It will be appreciated that the determining at act 730 may occur before the transmitting of the one or more status indications at act 725 since the status indications are based on decoding results that result from attempts to decode the traffic received at 715. If a determination is made at act 730 that an attempt to decode a packet by the XR processing unit was unsuccessful, in addition to transmitting a corresponding NACK indication to the serving RAN at act 725, responsive to transmitting the NACK status indication at act 725, the XR processing unit may receive a retransmission of a packet that was unsuccessfully decoded an to which the NACK status indication transmitted attack 725 corresponds.

Returning to description of act 730, if the extended reality processing unit determines that a packet was successfully decoded, in addition to transmitting at act 725 a corresponding ACK status indication indicative of the successful decoding of the packet, at act 735 the extended reality processing unit may store the successfully decoded packet to a memory. The memory may be part of, local to, or external to the extended reality processing unit. At act 740, the extended reality processing unit may transmit the packet that was successfully decoded at act 720, corresponding to an ACK status indication transmitted at act 725, and stored to the memory, or buffer at act 730, to an end XR appliance to which the packet is directed. At act 745, the extended reality processing unit may determine whether a positive status indication (e.g., an ACK) has been received from the end XR appliance to which the packet was transmitted at act 740. If a determination is made that a positive status indication corresponding to the packet transmitted at act 740 has not been received from the end extended reality appliance to which the packet was transmitted and act 740, the extended reality processing unit may retrieve the packet from the memory and retransmit the packet to the extended reality appliance to which the packet is directed. If the extended reality processing unit determines at act 745 that a positive status indication (e.g., an ACK) corresponding to the packet transmitted at act 740 has been received from the end XR appliance to which the packet was transmitted, at act 750 the extended reality processing unit may flush/erase/delete the packet from the memory. Method 700 ends at act 760.

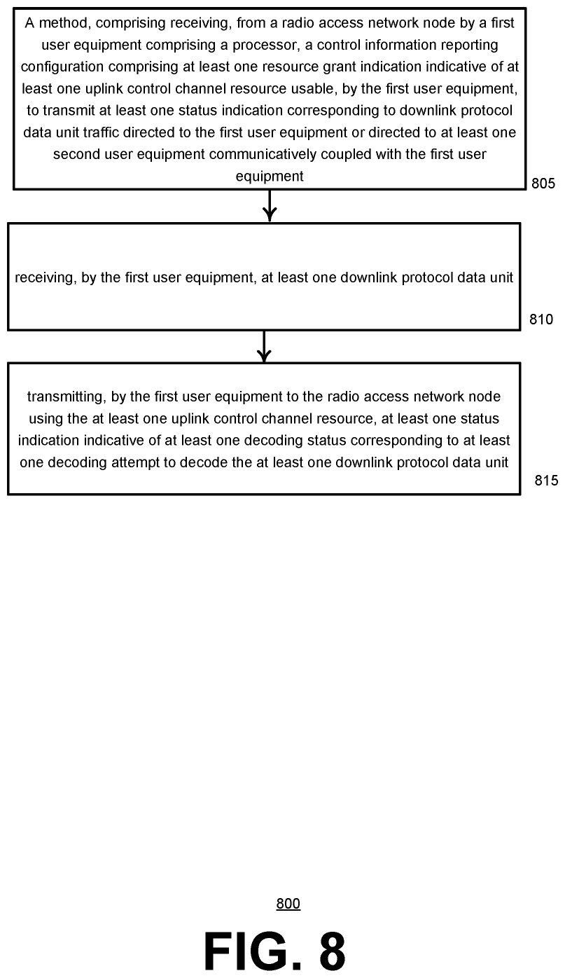

Turning now to FIG. 8, the figure illustrates an example embodiment method 800 comprising at block 805 receiving, from a radio access network node by a first user equipment comprising a processor, a control information reporting configuration comprising at least one resource grant indication indicative of at least one uplink control channel resource usable, by the first user equipment, to transmit at least one status indication corresponding to downlink protocol data unit traffic directed to the first user equipment or directed to at least one second user equipment communicatively coupled with the first user equipment; at block 810 receiving, by the first user equipment, at least one downlink protocol data unit; and at block 815 transmitting, by the first user equipment to the radio access network node using the at least one uplink control channel resource, at least one status indication indicative of at least one decoding status corresponding to at least one decoding attempt to decode the at least one downlink protocol data unit.

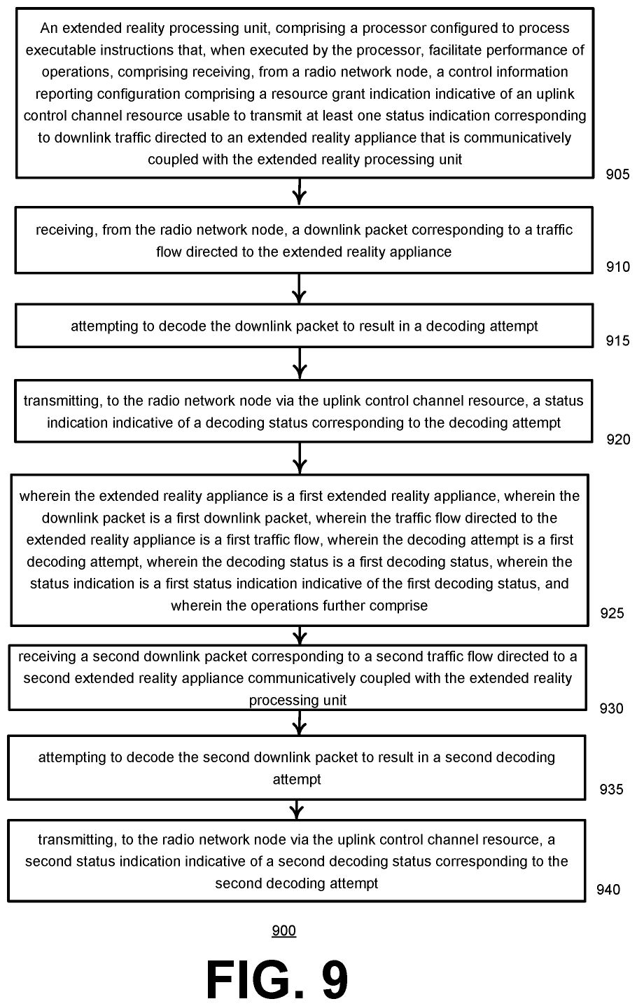

Turning now to FIG. 9, the figure illustrates an example extended reality processing unit, comprising at block 905 a processor configured to process executable instructions that, when executed by the processor, facilitate performance of operations, comprising receiving, from a radio network node, a control information reporting configuration comprising a resource grant indication indicative of an uplink control channel resource usable to transmit at least one status indication corresponding to downlink traffic directed to an extended reality appliance that is communicatively coupled with the extended reality processing unit; at block 910 receiving, from the radio network node, a downlink packet corresponding to a traffic flow directed to the extended reality appliance; at block 915 attempting to decode the downlink packet to result in a decoding attempt; at block 920 transmitting, to the radio network node via the uplink control channel resource, a status indication indicative of a decoding status corresponding to the decoding attempt; at block 925 wherein the extended reality appliance is a first extended reality appliance, wherein the downlink packet is a first downlink packet, wherein the traffic flow directed to the extended reality appliance is a first traffic flow, wherein the decoding attempt is a first decoding attempt, wherein the decoding status is a first decoding status, wherein the status indication is a first status indication indicative of the first decoding status, and wherein the operations further comprise; at block 930 receiving a second downlink packet corresponding to a second traffic flow directed to a second extended reality appliance communicatively coupled with the extended reality processing unit; at block 935 attempting to decode the second downlink packet to result in a second decoding attempt; and at block 940 transmitting, to the radio network node via the uplink control channel resource, a second status indication indicative of a second decoding status corresponding to the second decoding attempt.

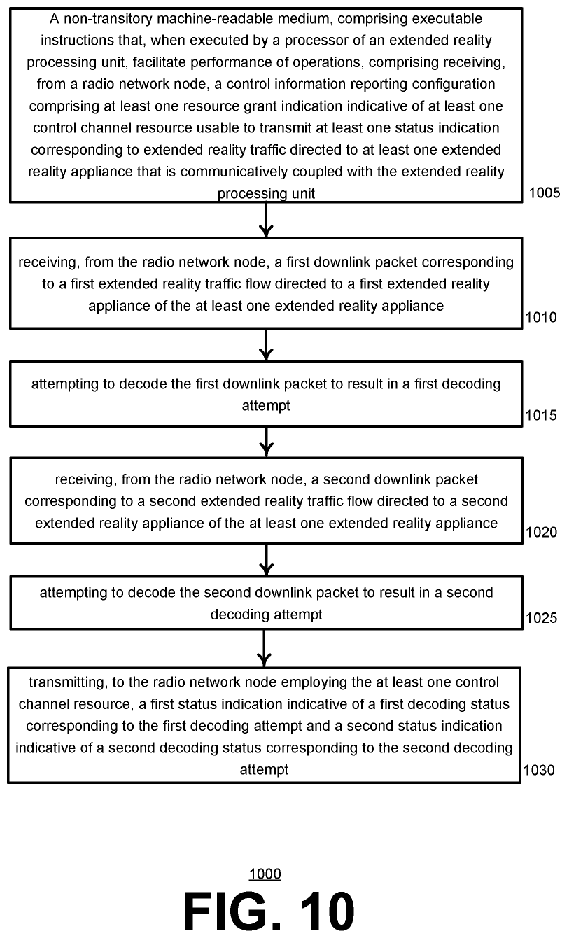

Turning now to FIG. 10, the figure illustrates a non-transitory machine-readable medium 1000 comprising at block 1005 executable instructions that, when executed by a processor of an extended reality processing unit, facilitate performance of operations, comprising receiving, from a radio network node, a control information reporting configuration comprising at least one resource grant indication indicative of at least one control channel resource usable to transmit at least one status indication corresponding to extended reality traffic directed to at least one extended reality appliance that is communicatively coupled with the extended reality processing unit; at block 1010 receiving, from the radio network node, a first downlink packet corresponding to a first extended reality traffic flow directed to a first extended reality appliance of the at least one extended reality appliance; at block 1015 attempting to decode the first downlink packet to result in a first decoding attempt; at block 1020 receiving, from the radio network node, a second downlink packet corresponding to a second extended reality traffic flow directed to a second extended reality appliance of the at least one extended reality appliance; at block 1025 attempting to decode the second downlink packet to result in a second decoding attempt; and at block 1030 transmitting, to the radio network node employing the at least one control channel resource, a first status indication indicative of a first decoding status corresponding to the first decoding attempt and a second status indication indicative of a second decoding status corresponding to the second decoding attempt.

In order to provide additional context for various embodiments described herein, FIG. 11 and the following discussion are intended to provide a brief, general description of a suitable computing environment 1100 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors and may include a cache memory. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

Computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid-state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can comprise a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Turning now to FIG. 12, the figure illustrates a block diagram of an example UE 1260. UE 1260 may comprise a smart phone, a wireless tablet, a laptop computer with wireless capability, a wearable device, a machine device that may facilitate vehicle telematics, and the like. UE 1260 comprises a first processor 1230, a second processor 1232, and a shared memory 1234. UE 1260 includes radio front end circuitry 1262, which may be referred to herein as a transceiver, but is understood to typically include transceiver circuitry, separate filters, and separate antennas for facilitating transmission and receiving of signals over a wireless link, such as one or more wireless links 125, 135, or 137 shown in FIG. 1. Furthermore, transceiver 1262 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 12, UE 1260 may also include a SIM 1264, or a SIM profile, which may comprise information stored in a memory (memory 1234 or a separate memory portion), for facilitating wireless communication with RAN 105 or core network 130 shown in FIG. 1. FIG. 12 shows SIM 1264 as a single component in the shape of a conventional SIM card, but it will be appreciated that SIM 1264 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 1264 and another device, which may be a component of RAN 105 or core network 130 shown in FIG. 1). A SIM profile 1264 may also comprise identifying information that is unique to the SIM, or SIM profile, such as, for example, an International Mobile Subscriber Identity (“IMSI”) or information that may make up an IMSI.

SIM 1264 is shown coupled to both the first processor portion 1230 and the second processor portion 1232. Such an implementation may provide an advantage that first processor portion 1230 may not need to request or receive information or data from SIM 1264 that second processor 1232 may request, thus eliminating the use of the first processor acting as a ‘go-between’ when the second processor uses information from the SIM in performing its functions and in executing applications. First processor 1230, which may be a modem processor or baseband processor, is shown smaller than processor 1232, which may be a more sophisticated application processor, to visually indicate the relative levels of sophistication (i.e., processing capability and performance) and corresponding relative levels of operating power consumption levels between the two processor portions. Keeping the second processor portion 1232 asleep/inactive/in a low power state when UE 1260 does not need it for executing applications and processing data related to an application provides an advantage of reducing power consumption when the UE only needs to use the first processor portion 1230 while in listening mode for monitoring routine configured bearer management and mobility management/maintenance procedures, or for monitoring search spaces that the UE has been configured to monitor while the second processor portion remains inactive/asleep.

UE 1260 may also include sensors 1266, such as, for example, temperature sensors, accelerometers, gyroscopes, barometers, moisture sensors, and the like that may provide signals to the first processor 1230 or second processor 1232. Output devices 1268 may comprise, for example, one or more visual displays (e.g., computer monitors, VR appliances, and the like), acoustic transducers, such as speakers or microphones, vibration components, and the like. Output devices 1268 may comprise software that interfaces with output devices, for example, visual displays, speakers, microphones, touch sensation devices, smell or taste devices, and the like, that are external to UE 1260.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| DRX | Discontinuous reception |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| UE | User equipment |
| CBR | Channel busy ratio |
| SCI | Sidelink control information |
| SBFD | Sub-band full duplex |
| CLI | Cross link interference |
| TDD | Time division duplexing |
| FDD | Frequency division duplexing |
| BS | Base-station |
| RS | Reference signal |
| CSI-RS | Channel state information reference signal |
| PTRS | Phase tracking reference signal |
| DMRS | Demodulation reference signal |
| gNB | General NodeB |
| PUCCH | Physical uplink control channel |
| PUSCH | Physical uplink shared channel |
| SRS | Sounding reference signal |
| NES | Network energy saving |
| QCI | Quality class indication |
| RSRP | Reference signal received power |
| PCI | Primary cell ID |
| BWP | Bandwidth Part |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, from a radio access network node by a first user equipment comprising a processor, a control information reporting configuration comprising at least one resource grant indication indicative of at least one uplink control channel resource usable, by the first user equipment, to transmit at least one status indication corresponding to downlink protocol data unit traffic directed to the first user equipment or directed to at least one second user equipment communicatively coupled with the first user equipment;
receiving, by the first user equipment, at least one downlink protocol data unit; and
transmitting, by the first user equipment to the radio access network node using the at least one uplink control channel resource, at least one status indication indicative of at least one decoding status corresponding to at least one decoding attempt to decode the at least one downlink protocol data unit.

2. The method of claim 1, wherein the at least one downlink protocol data unit is directed to the at least one second user equipment.

3. The method of claim 1, wherein the at least one decoding status corresponds to the at least one decoding attempt, by the first user equipment, having been determined to be at least one failure to successfully decode the at least one downlink protocol data unit, and wherein the at least one status indication comprises at least one negative acknowledgement (“NACK”) indicative of the at least one failure to successfully decode the at least one downlink protocol data unit.

4. The method of claim 1, wherein the at least one decoding status is a first decoding status, wherein the at least one status indication is a first status indication, wherein the at least one decoding attempt is a first decoding attempt, by the first user equipment, to decode the at least one downlink protocol data unit, wherein the first decoding status is an acknowledgement indication indicative of a first result of the first decoding attempt being a successfully decoded downlink protocol data unit, and further comprising:
storing, by the first user equipment to a memory, the successfully decoded downlink protocol data unit;
transmitting, by the first user equipment to the at least one second user equipment, the successfully decoded downlink protocol data unit;
receiving, by the first user equipment from the at least one second user equipment, a second status indication indicative of a second decoding attempt, by the at least one second user equipment, to decode the successfully decoded downlink protocol data unit; and
based on the second status indication, performing, by the first user equipment, a communication operation with respect to the successfully decoded downlink protocol data unit.

5. The method of claim 4, wherein the second status indication is indicative of the second decoding attempt, by the at least one second user equipment, having been determined to be a failure to successfully decode the successfully decoded downlink protocol data unit, and wherein the communication operation comprises retransmitting, by the first user equipment to the at least one second user equipment, the successfully decoded downlink protocol data unit.

6. The method of claim 5, wherein the receiving of the second status indication and the retransmitting of the successfully decoded downlink protocol data unit to the at least one second user equipment facilitate avoiding, by the at least one second user equipment, transmitting, to the radio access network node, the second status indication indicative of the failure, by the at least one second user equipment, to successfully decode the successfully decoded downlink protocol data unit.

7. The method of claim 6, wherein the second status indication comprises a NACK indication.

8. The method of claim 4, wherein the second status indication is indicative of the second decoding attempt, by the at least one second user equipment, having been determined to be a success in decoding the successfully decoded downlink protocol data unit, and wherein the communication operation comprises flushing, by the first user equipment from the memory, the successfully decoded downlink protocol data unit.

9. The method of claim 1, wherein a first downlink protocol data unit of the at least one downlink protocol data unit is directed to the first user equipment, wherein a second downlink protocol data unit of the at least one downlink protocol data unit is directed to the at least one second user equipment, wherein a first status indication of the at least one status indication is indicative of a first decoding status of the at least one decoding status corresponding to a first decoding attempt of the at least one decoding attempt, by the first user equipment, to decode the first downlink protocol data unit, and wherein a second status indication of the at least one status indication is indicative of a second decoding status of the at least one decoding status corresponding to a second decoding attempt of the at least one decoding attempt, by the at least one second user equipment, to decode the second downlink protocol data unit.

10. The method of claim 9, wherein the control information reporting configuration comprises a transmission multiplexing format indication indicative of a transmission multiplexing format usable by the first user equipment to transmit, to the radio access network node, the at least one status indication, and wherein the first status indication and the second status indication are transmitted, using the at least one uplink control channel resource, according to a status indication multiplexing format.

11. The method of claim 10, wherein the status indication multiplexing format is one of: a code multiplexing format or a sequence multiplexing format.

12. An extended reality processing unit, comprising:
a processor configured to process executable instructions that, when executed by the processor, facilitate performance of operations, comprising:
receiving, from a radio network node, a control information reporting configuration comprising a resource grant indication indicative of an uplink control channel resource usable to transmit at least one status indication corresponding to downlink traffic directed to an extended reality appliance that is communicatively coupled with the extended reality processing unit;
receiving, from the radio network node, a downlink packet corresponding to a traffic flow directed to the extended reality appliance;
attempting to decode the downlink packet to result in a decoding attempt; and
transmitting, to the radio network node via the uplink control channel resource, a status indication indicative of a decoding status corresponding to the decoding attempt.

13. The extended reality processing unit of claim 12, wherein the extended reality appliance is a first extended reality appliance, wherein the downlink packet is a first downlink packet, wherein the traffic flow directed to the extended reality appliance is a first traffic flow, wherein the decoding attempt is a first decoding attempt, wherein the decoding status is a first decoding status, wherein the status indication is a first status indication indicative of the first decoding status, and wherein the operations further comprise:
receiving a second downlink packet corresponding to a second traffic flow directed to a second extended reality appliance communicatively coupled with the extended reality processing unit;
attempting to decode the second downlink packet to result in a second decoding attempt; and
transmitting, to the radio network node via the uplink control channel resource, a second status indication indicative of a second decoding status corresponding to the second decoding attempt.

14. The extended reality processing unit of claim 13, wherein the first status indication and the second status indication are transmitted in an uplink control information message.

15. The extended reality processing unit of claim 14, wherein the first status indication and the second status indication are multiplexed in the uplink control information message according to one of: a code-based multiplexing format or a sequence-based multiplexing format.

16. The extended reality processing unit of claim 13, wherein the first decoding status corresponds to a first successful decoding of the first downlink packet, wherein the first status indication is an ACK indicative of the first successful decoding of the first downlink packet, and wherein the operations further comprise:
storing the first downlink packet to a memory;
transmitting the first downlink packet to the first extended reality appliance;
responsive to the transmitting of the first downlink packet to the first extended reality appliance, receiving a third status indication indicative of a second successful decoding, by the first extended reality appliance, of the first downlink packet; and
responsive to the receiving of the third status indication, erasing the first downlink packet from the memory.

17. The extended reality processing unit of claim 13, wherein the first decoding status corresponds to a successful decoding of the first downlink packet, wherein the first status indication is an ACK indicative of the successful decoding of the first downlink packet, and wherein the operations further comprise:
storing the first downlink packet to a memory;
transmitting the first downlink packet to the first extended reality appliance;
responsive to the transmitting of the first downlink packet to the first extended reality appliance, receiving a third status indication indicative of an unsuccessful decoding, by the first extended reality appliance, of the first downlink packet; and
responsive to the receiving of the third status indication, retransmitting the first downlink packet to the first extended reality appliance.

18. The extended reality processing unit of claim 12, wherein the downlink packet is a first downlink packet, wherein the decoding attempt corresponds to a failure, by the extended reality processing unit, to decode the downlink packet, wherein the status indication comprises a negative acknowledgement (“NACK”), and wherein the operations further comprise:
responsive to the transmitting of the NACK, receiving, from the radio network node, a second downlink packet that is a retransmitted version of the first downlink packet;
successfully decoding the second downlink packet to result in a successfully decoded second downlink packet;
storing the successfully decoded second downlink packet to a memory; and
transmitting the successfully decoded second downlink packet to the extended reality appliance.

19. A non-transitory machine-readable medium, comprising executable instructions that, when executed by a processor of an extended reality processing unit, facilitate performance of operations, comprising:
receiving, from a radio network node, a control information reporting configuration comprising at least one resource grant indication indicative of at least one control channel resource usable to transmit at least one status indication corresponding to extended reality traffic directed to at least one extended reality appliance that is communicatively coupled with the extended reality processing unit;
receiving, from the radio network node, a first downlink packet corresponding to a first extended reality traffic flow directed to a first extended reality appliance of the at least one extended reality appliance;
attempting to decode the first downlink packet to result in a first decoding attempt;
receiving, from the radio network node, a second downlink packet corresponding to a second extended reality traffic flow directed to a second extended reality appliance of the at least one extended reality appliance;
attempting to decode the second downlink packet to result in a second decoding attempt; and
transmitting, to the radio network node employing the at least one control channel resource, a first status indication indicative of a first decoding status corresponding to the first decoding attempt and a second status indication indicative of a second decoding status corresponding to the second decoding attempt.

20. The non-transitory machine-readable medium of claim 19, wherein the first status indication is a negative acknowledgement (“NACK”) wherein the second status indication is an acknowledgement (“ACK”), and wherein the operations further comprise:
storing the second downlink packet to a memory of the extended reality processing unit;
transmitting, to the second extended reality appliance the second downlink packet;
responsive to the transmitting of the NACK, receiving from the radio network node, a retransmitted version of the first downlink packet;
storing the retransmitted version of the first downlink packet to the memory; and
transmitting to the first extended reality appliance the retransmitted version of the first downlink packet.
